(19) United States
(12) Patent Application Publication
(10) Pub. No.: US 2025/0162245 A1
(43) Pub. Date: May 22, 2025

(54) EMBEDDED FEATURES IN THREE DIMENSIONAL PRINTED PARTS

(71) Applicant: Hewlett-Packard Development Company, L.P., Spring, TX (US)

(72) Inventors: Emre Hiro Discekici, San Diego, CA (US); Emily Levin, San Diego, CA (US); Jake H. Thomas, San Diego, CA (US)

(21) Appl. No.: 18/833,336

(22) PCT Filed: Feb. 3, 2022
(86) PCT No.: PCT/US2022/015059

§ 371 Date: Jul. 25, 2024

(51) Int. Cl. B29C 64/165; B29C 64/255; B29C 64/264; B29K 77/00; B29L 17/00; B33Y 10/00; B33Y 30/00; B33Y 80/00

(52) U.S. Cl. CPC B29C 64/165; B29C 64/255; B29C 64/264; B33Y 10/00; B33Y 30/00; B33Y 80/00; B29K 2077/00; B29K 2995/0026; B29L 2017/00

(57) ABSTRACT

In example implementations, a method is disclosed. The method includes dispensing a layer of an optically clear build material, dispensing a fusing agent onto a first portion of the layer of the optically clear build material, dispensing an invisible fluorescence compound on a second portion of the layer of the optically clear build material, and applying ultraviolet (UV) light to the layer to fuse the first portion and the second portion of the optically clear build material that received the fusing agent and the invisible fluorescence compound. The invisible fluorescence compound is to print an embedded feature in the layer that is invisible under a first light and visible under a second light.

### BACKGROUND

Three-dimensional (3D) printing may include additive printing processes used to make three-dimensional solid parts from digital models. 3D printing can be often used in rapid product prototyping, mold generation, mold master generation, and short run manufacturing. Some 3D printing techniques are considered additive processes because they involve the application of successive layers of material. This is unlike customary machining processes, which often rely upon the removal of material to create the final part. 3D printing can often use curing or fusing of the build material, which for some materials may be accomplished using heat-assisted extrusion, melting, or sintering.

### BRIEF DESCRIPTION OF THE DRAWINGS

FIG. 1 is a block diagram of an example three-dimensional printing kit in accordance with the present disclosure;

FIG. 2 is a block diagram of another example three-dimensional printing kit in accordance with the present disclosure;

FIG. 3 is a schematic illustration of an example three-dimensional printing system that uses the three-dimensional printing kit of the present disclosure;

FIG. 4 is a schematic illustration of another example three-dimensional printing system that uses the three-dimensional printing kit of the present disclosure;

FIG. 5 is a flowchart illustrating an example method of printing a three-dimensional object with an embedded feature of the present disclosure;

FIG. 6 illustrates an example of a 3D printed object with an embedded feature under a first lighting condition; and

FIG. 7 illustrates an example of the 3D printed object with the embedded feature under a second lighting condition.

### DETAILED DESCRIPTION

Examples described herein provide three dimensional (3D) printed parts with embedded features. As discussed above, 3D printing may include additive printing processes that are used to make 3D solid parts from digital models. 3D printing includes adding layers of build material. Layers of each object are “printed” in the build material with a fusing agent. The fusing agent absorbs light energy and converts the light energy into heat to heat a build material to a melting temperature of the build material. The build material can then be fused back together as the build material re-solidifies.

An additive printing process can be used to print a variety of different objects for different uses. The 3D printed objects can be printed with different colors and designs.

Some printing technologies, such as selective laser sintering (SLS) or multi-jet fusion (MJF) 3D printing, may print 3D parts using polymer build materials. MJF 3D printing technologies use a tungsten bronze low tint fusing agent (LTFA) that is fused with near infrared emitting light sources (e.g., wavelengths of light around 1000 nanometers (nm)). However, these LTFAs can include cesium tungsten oxide which carries a blue tint. Thus, printing truly colorless parts can be impossible using LTFAs.

The present disclosure uses a colorless UV absorber and an invisible fluorescence compound (IFC) that can be used to print embedded features in the 3D printed parts. The colorless UV absorber and the IFC can be used with an optically clear build material to print the embedded features. The embedded features may appear invisible in the 3D printed part under a first lighting condition (e.g., under visible light), but then appear visible under different lighting conditions (e.g., under UV light). Thus, the embedded features can be used as security marks or labeling within the 3D printed part.

In another example, the IFC may be formulated in an aqueous vehicle without a UV absorber in a jettable formulation. In an example, the IFC may be mixed with a UV absorber and dispensed as the UV fusing agent.

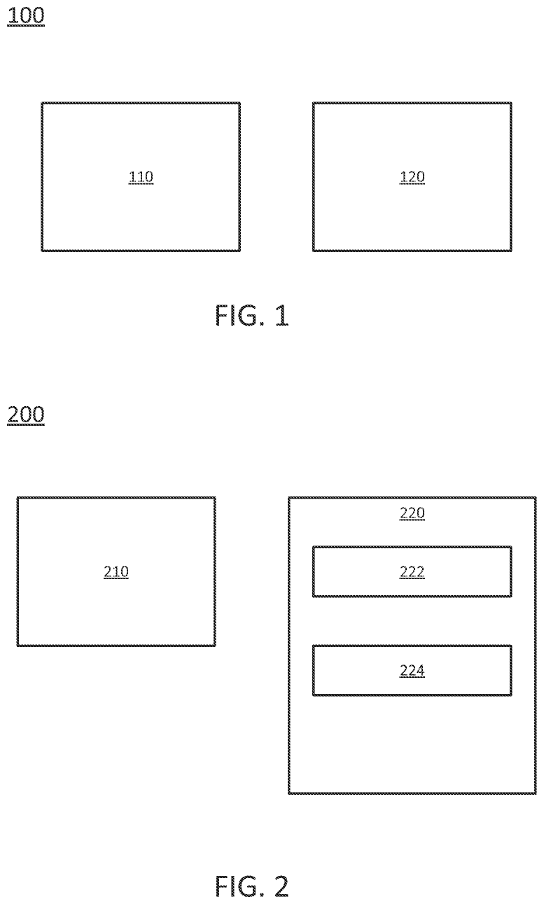

FIG. 1 illustrates a schematic illustration of an example three-dimensional printing kit 100 of the present disclosure. Three-dimensional printing kits can be used to make three-dimensional printed objects. A certain three-dimensional printing, or additive manufacturing, process can be performed using the materials described herein. In an example, UV fusing agents can be applied to layers of the build material. Successive layers of the build material can be added, and the UV fusing agents can be applied on the layers to fuse the particles of the build material together to form layers of a three-dimensional printed part.

In an example, the three-dimensional printing kit 100 of the present disclosure may include a build material 110 and a UV fusing agent kit 120 that may include a UV fusing agent and an invisible fluorescence compound. The build material 110 may be a powder. In an example, the build material 110 may be an optically clear polymer powder. Optically clear build materials may be transparent. In other words, optically clear build material may be defined as material that allows more than 50% of visible light to pass through the material. In an example, the thickness of the 3D printed part may affect how much light is allowed to pass through. For example, optically clear may also be defined as material having an average thickness of 5 millimeters (mm) that allows more than 50% of visible light to pass through.

An example of an optically clear build material may include a thermoplastic polyamide. Other example build materials include nylon, polycarbonate, or polypropylene based materials.

In an example, when the build material is in a powder form, the build material may be made up of similarly sized particles or differently sized particles. Size, as used herein, refers to the diameter of a spherical particle, or the average diameter of a non-spherical particle. In some examples, the average size of the particles of the build material in the build material composition ranges from about 10 micrometer (μm) to about 100 μm or about 40 μm to about 50 μm. In some examples, the diameter or average diameter of the particles may be measured using an analytical chemical analysis. For example, the average diameter of the particles may be measured using a volume based size distribution. The size of the particles may be measured by using a static light scattering technique, such as laser diffraction.

In an example, the UV fusing agent kit 120 may include a UV light absorber that absorbs UV light that is solubilized in an aqueous based ink vehicle. The UV light may have a wavelength between 320 nanometers (nm) to 400 nm. In an example, the UV wavelength of light may be approximately 365 nm.

The UV fusing agent kit 120 may also include an invisible fluorescence compound (IFC). The IFC may be dispensed in an aqueous vehicle on desired locations within desired layers of the build material 110 to print an embedded feature. In an example, the embedded feature may be a mark that is printed between a first printed layer and a last printed layer of a 3D printed object. In an example, the embedded feature may be printed between the first several printed layers and the last several printed layers of the 3D printed object. In other words, the embedded feature is not a mark that is printed on an outward-facing surface of the 3D printed object (e.g., on the first layer or the last layer of the 3D printed object).

The embedded feature may be invisible under a first lighting condition (e.g., visible light having a wavelength greater than 400 nm), but may be visible under a second lighting condition (e.g., UV light having a wavelength of light less than 400 nm). The embedded feature can provide a security mark that can be impossible to alter or remove without damaging the 3D printed mark. The embedded feature can also provide new aesthetics to 3D printed parts as well. FIG. 2 illustrates different formulations of the UV fusing agent 120.

FIG. 2 illustrates a schematic illustration of another example three-dimensional printing kit 200 of the present disclosure. In an example, three-dimensional printing kit 200 may include a build material 210 and a UV fusing agent 220.

In an example, the build material 210 may be similar to the build material 110 illustrated in FIG. 1, and described above. In an example, the build material 210 may be an optically clear polymer or elastomer powder.

In an example, the UV fusing agent 220 may include a UV light absorber 222 and an invisible fluorescence compound (IFC) 224. Although the IFC 224 is shown as part of the UV fusing agent 220 (e.g., a spiked UV fusing agent 220), it should be noted that the clear fluorescence compound/additive 224 may be dispensed separately, as a separate invisible fluorescence agent without any UV absorber, over a UV fusing agent without the IFC 224 that is dispensed to print each layer of the 3D printed part.

The UV light absorber 222 may be any type of clear or colorless UV light absorber. For example, the UV light absorber may be any type of clear or colorless radiation absorber that can absorb light having wavelengths between 320 nm to 400 nm. In an example, the UV light absorber 222 may be a substituted cresol. In an example, the UV light absorber 222 may be phenol, 2-(2H-benzotrizol-2-yl)-6-dodecyl-4-4methyl-, also known by the trade name Tinogard TL. In an example, the UV light absorber 222 may also be avobenzone, diethylamino hydroxybenzoyl hexyl benzoate, and the like.

In an example, the IFC 224 may include any type of colorless or clear fluorescence compound/additive. In an example, the fluorescence compound in the IFA 224 may include one of TINOPAL® SFP, TINOPAL® CBS SP, TINOPAL® CBS-CL, TINOPAL® CBS-X, TINOPAL® DMA-X, TINOPAL® NFWLIQ, or combinations thereof-all available from BASF Corp (Germany). The colorless or clear fluorescence compound may be mixed with other solvents and/or compounds to form the IFA.

An example chemical structure of Tinopal SFP that is used as an example fluorescence additive is shown below:

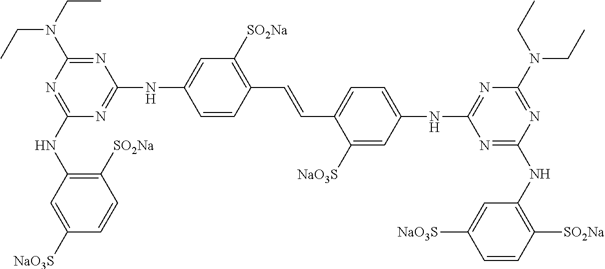

It should be noted that the chemical structures of the other fluorescence compounds that are listed may be a derivative of the example structure shown above for Tinopal SFP.

In an example, the UV agent 220 may include additional compounds. For example, the UV agent 220 may be an aqueous solution formed in water. The UV agent 220 may also include a surfactant, a polyamide plasticizer co-solvent, a solubilizing co-solvent, and an additional solubilizer/crystallization inhibitor. The surfactant may improve jettability of the aqueous UV agent 220 and may include Tergitol 15-S-9.

The first co-solvent may be a polyamide plasticizer and/or have plasticizing characteristics when interacting with the build material 210. For example, the first co-solvent may interact with the build material 210 to lower the melting temperature of the build material 210. As a result, less UV light absorber 222 may be used, and less energy may be used to melt the build material 210. The first co-solvent may be an organic solvent, such as benzyl alcohol.

The second co-solvent may be a solubilizer or a water miscible solvent that is compatible with the UV light absorber 222. The second co-solvent may help keep the UV light absorber 222 dissolved in water and help provide stability and prevent aggregation of the UV light absorber 222 over time. In other words, the UV light absorber 222 is solubilized and not a dispersion. The second co-solvent may include at least one of diethylene glycol (DEG) butyl ether, 1,2-hexanediol, hydroxyethyl-2-pyrrolidone (HE2P), 1,3 propane diol, propylene glycol, or 1,5-pentane diol.

In an example, the additional solubilizer/crystallization inhibitor may help the UV light absorber 222 to remain in solution and provide additional stability of the UV fusing agent 220 over time. Examples of the additional solubilizer may include Kolliphor RH40, BRIJ L23, and the like.

In an example, the formulation of the UV fusing agent 220 may include 0.3-5 wt % of the UV light absorber 222 and 0.3-5 wt % of the IFC 224.

In an example, the formulation of the UV fusing agent 220 may include 1-20 wt % of the first plasticizer co-solvent. In an example, the UV fusing agent 220 may include between 10-20 wt % of the first co-solvent. In an example, the UV fusing agent 220 may include approximately 16 wt % of the first co-solvent.

In an example, the formulation of the UV fusing agent 220 may include 20-60 wt % of the second solubilizer co-solvent. In an example, the UV fusing agent 220 may include between 40 to 60 wt % of the second co-solvent. In an example, the UV fusing agent 220 may include approximately 50 wt % of the second co-solvent.

In an example, the formulation of the UV fusing agent 220 may include between 0.1 to 1 wt % of the surfactant. In an example, the aqueous UV fusing agent 220 may include approximately 0.80 wt % of the surfactant.

In an example, the formulation of the aqueous UV fusing agent 220 may include between 1-3 wt % of the additional solubilizer. In an example, the formulation of the aqueous UV fusing agent 220 may include approximately 3 wt % of the additional solubilizer.

An example formulation of the UV fusing agent 220 that includes the IFC 224 is shown below in Example 1:

Example 1:

| Component | wt % |
|---|---|
| UV Absorber (e.g., | 2 |
| Avobenzone, Tinogard, | |
| uvinul) | |
| DEGBE | 65 |
| BRIJ 23 | 2 |
| Tergitol 15-S-9 | 0.75 |
| Tinopal SFP | 2 |
| Water | 28.2 |

As noted above, the IFC 224 may be deployed in an aqueous vehicle as an IFA that does not contain a UV absorber. An example formulation of the IFA is provided in Example 2: below.

Example 2:

| Component | wt % |
|---|---|
| HE2P | 50 |
| Benzyl alcohol | 16 |
| Tinopal SFP | 3 |
| Tergitol 15-S-9 | 0.8 |
| Water | 30.2 |

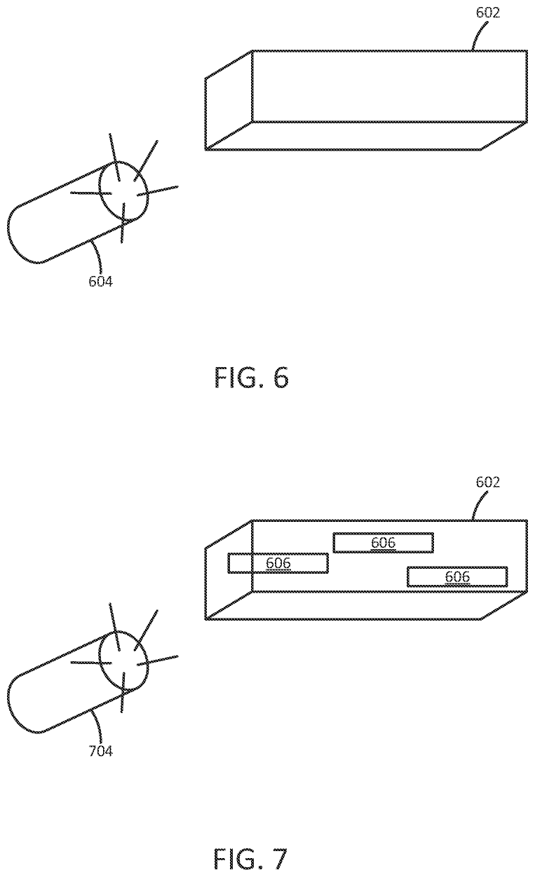

FIGS. 6 and 7 illustrate an example of a 3D printed object with embedded features that can be printed with the printing kit 100 or 200 of the present disclosure. FIG. 6 illustrates an example of a 3D printed object 602 with embedded features. When exposed to a first light source 604, the embedded features may not be visible in the object 602. For example, the object 602 may appear clear with no occlusions, images, patterns, or text that can be seen under the first light source 604.

In an example, the first light source 604 may be a light source that emits visible wavelengths of light. For example, the light source 604 may emit light having a wavelength of greater than 400 nm. The first light source 604 may be an incandescent light bulb or a light emitting diode (LED) light bulb.

FIG. 7 illustrates the 3D printed object 602 when exposed to a second light source 704. The second light source 704 may be a different light source than the first light source 604. The second light source 704 may be a light source that emits ultraviolet light or light having a wavelength less than 400 nm. In an example, the second light source 704 may emit light having a wavelength of 395 nm.

When exposed to the second light source 704, the embedded features 606 in the 3D printed object 602 may be visible. The embedded features 606 may form an image, text, a pattern, and the like. The embedded features 606 may be printed inside of the 3D printed object 602. As a result, it may be difficult to alter, remove, or tamper with the embedded features 606. However, in some examples, the embedded features 606 may be located near or on the surface of the 3D printed object 602.

In an example, the embedded features 606 may also be three-dimensional. For example, the embedded features 606 may be printed over multiple layers of the 3D printed object 602 to have three-dimensions.

In an example, the 3D printed object 602 may include multiple embedded features 606. The embedded features 606 may be dispersed at different locations within the 3D printed object 602. Although three embedded features 606 are illustrated in FIG. 7, it should be noted that any number of embedded features 606 may be printed. In an example, a single embedded feature 606 may be printed inside of the 3D printed object 602.

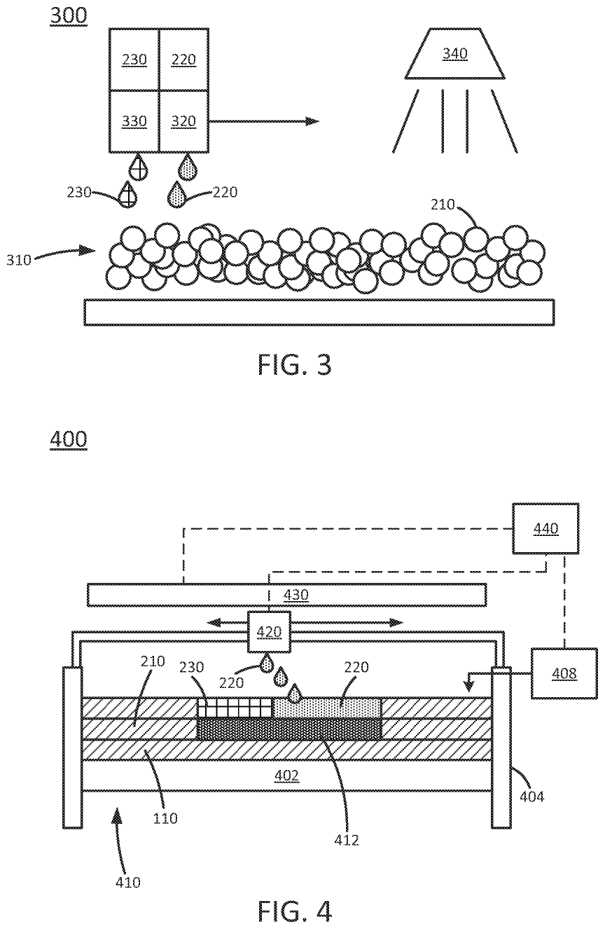

FIG. 3 illustrates an example of a three-dimensional printing system 300 that can use the three-dimensional printing kit 100 or 200 described above. The three-dimensional printing system 300 can be used with three-dimensional printing kit 100 or 200 described herein to make three-dimensional printed objects. In some examples, a three-dimensional printing system can include a powder bed for holding layers of the build material. A first UV fusing agent applicator 320 can be positioned to selectively apply the UV fusing agent 120 or 220 with the IFC 224, or a standalone IFA with the IFC 224 and no UV absorber, onto the layers of build material 110 or 210 that are to be marked with the embedded feature.

However, as noted above, an IFA with the IFC 224 and no UV absorber (e.g., the formulation provided in Example 1 above) may be dispensed instead of the UV fusing agent 220 with the IFC 224.

A second UV fusing agent applicator 330 can be positioned to selectively apply a UV fusing agent 230 without the IFC 224 onto portions of the layers of the build material 110 or 210 that are to be printed as part of the 3D printed object. In an example, the UV fusing agent 230 without the IFC 224 can be dispensed first to define the portions of the layer of build material 210 that is to be part of the 3D printed part. The UV fusing agent 230 with the IFC 224, or the IFA with the IFC 224 and no UV absorber, may then be dispensed over the UV fusing agent 230 on the portions that are to be marked with the embedded feature.

An example formulation of the UV fusing agent 230 without the IFC 224 is shown below in Example 3:

Example 3:

| Component | wt % |
|---|---|
| UV Absorber (e.g., | 2 |
| Avobenzone, | |
| Tinogard, uvinul) | |
| DEGBE | 65 |
| BRIJ 23 | 2 |
| Tergitol 15-S-9 | 0.75 |
| Water | 30.25 |

The first UV fusing agent applicator 320 and the second UV fusing agent applicator 330 can be controllable to apply the UV fusing agent 220 with the IFC 224 and the UV fusing agent 230 at specific x/y coordinates of the layer of build material 210. Additionally, the three-dimensional printing systems can include a fusing lamp 340. As used herein, “fusing” can refer to a process of heating the build material 110 or 210 and the UV fusing agents 120 or 220 so that build material is melted and then allowed to fuse back together when cooled.

In an example, the three-dimensional printing system 300 may include a powder bed 310. The example illustrated in FIG. 3 uses the build material 210 and the UV fusing agents 220. However, it should be noted that the three-dimensional printing system 300 may also use the build material 110 and the UV fusing agent 120.

In an example, the powder bed 310 includes a layer of the build material 210. As noted above, the build material 210 includes particles of an optically clear polymer or elastomer. The printing system 300 may also include a first UV fusing agent applicator 320 and a second UV fusing agent applicator 330. The first UV fusing agent applicator 320 is fluidly coupled to a UV fusing agent 220 with the IFC 224. The second UV fusing agent applicator 330 is fluidly coupled to a UV fusing agent 230 that does not include the IFC 224. The first UV fusing agent applicator 320 and the second UV fusing agent applicator 330 can be controlled to iteratively apply the UV fusing agent 220 with the IFC 224 and the UV fusing agent 230 without the IFC 224 on desired locations of layers of the build material 210.

The printing system 300 may also include a fusing lamp 340 positioned to emit wavelengths of light to be absorbed by the UV fusing agents 220 and 230. The fusing lamp 340 may emit light having a UV wavelength (e.g., between 320 nm to 400 nm). In an example, the fusing lamp 340 may emit light having a wavelength of approximately 365 nm. The absorbed light can be converted into heat to melt the particles of the build material 210.

It should be noted that the three-dimensional printing system 300 has been simplified for ease of explanation and can include a variety of additional components (e.g., a detailing agent) besides the components shown in FIG. 3. Examples of additional components include a build material distributor, a supply of additional build material, a hardware controller to send instructions to other components in the system, a non-transitory computer readable medium having stored computer executable instructions to cause the hardware controller to send instructions to other components of the system to perform a three-dimensional printing method, a sintering oven, and the like.

FIG. 4 illustrates another example three-dimensional printing system 400. The example printing system 400 illustrated in FIG. 4 uses the build material 210 and the UV fusing agent 220 with the IFC 224. However, the printing system 400 may also use the build material 110 and the UV fusing agent 120.

In an example, the printing system 400 includes a powder bed 410 having a build material platform 402 and side walls 404. A build material applicator 408 is configured to deposit individual layers of the build material 210.

The printing system 400 may also include a UV fusing agent applicator 420 that is positioned above the powder bed 410. The UV fusing agent applicator 420 may be moveable so that the UV fusing agent applicator 420 can apply the UV fusing agent 220 with the IFC 224 on to the layers of the build material 210. In an example, the UV fusing agent applicator 420 may also be used apply the UV fusing agent 230 without the IFC 224.

A fusing lamp 430 may be positioned to emit wavelengths of light that are absorbed by the aqueous UV fusing agents 220 and 230. The absorbed light can be converted into heat to heat the powder bed 410. In this example, the fusing lamp 430 may heat the individual layers of the build material 210 after the UV fusing agent 220 with the IFC 224 and the UV fusing agent 230 without the IFC 224 are applied to selective areas of a layer of the build material 210 to form layers 412 of the 3D printed part.

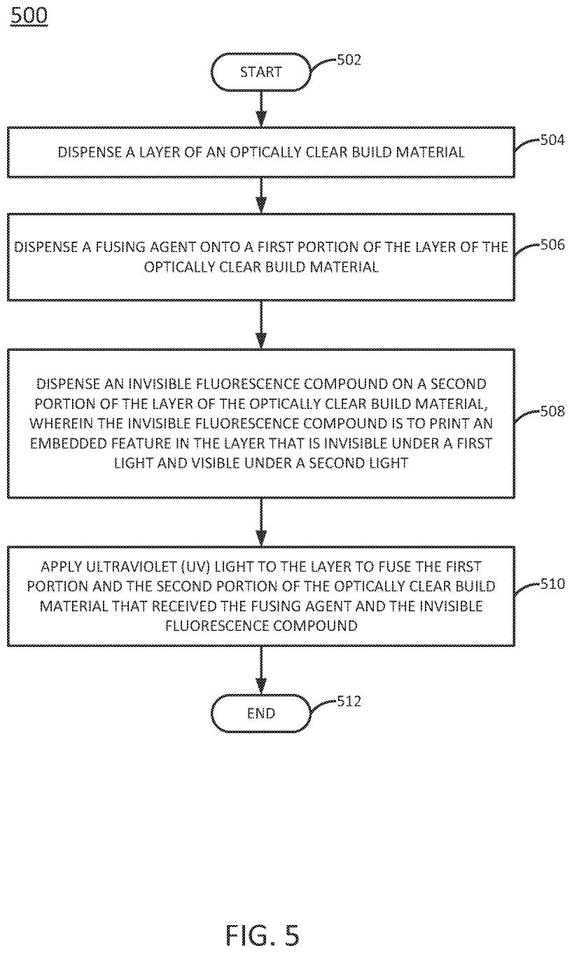

The printing system 400 may also include a hardware controller 440 or processor. The hardware controller 440 may communicate with the fusing lamp 430, the UV fusing agent applicator 420, and the build material applicator 408 to send instructions to the fusing lamp 430, the UV fusing agent applicator 420, and the build material applicator 408 to perform a three-dimensional printing method (e.g., the method 500 illustrated in FIG. 5, and described below).

In some examples, the UV fusing agent applicator 420 can be moveable along two axes, such as an x-axis and a y-axis, to allow the UV fusing agent 220 with the IFC 224 and the UV fusing agent 230 without the IFC 224 to be selectively applied to any desired location on the layers of build material 210. In other examples, the UV fusing agent applicator 420 can be large enough to extend across one entire dimension of the powder bed 410, and the UV fusing agent applicator 420 can be moveable along one axis.

For example, the UV fusing agent applicator 420 can include a plurality of nozzles along the length of the UV fusing agent applicator 420, and the UV fusing agent 220 with the IFC 224 and the UV fusing agent 230 without the IFC 224 can be selectively jetted from the individual nozzles. The UV fusing agent applicator 420 can then scan across the powder bed 410 and the UV fusing agent 220 with the IFC 224 and/or the UV fusing agent 230 without the IFC 224 can be selectively jetted from the nozzles to allow the UV fusing agent 220 with the IFC 224 and/or the UV fusing agent 230 without the IFC 224 to be applied to any desired location on the powder bed 410.

In other examples, the powder bed 410 itself can be moveable. For example, the powder bed 410 can be moveable and the UV fusing agent applicator 420 can be stationary. In either example, the UV fusing agent applicator 420 and the powder bed 410 can be configured so that the UV fusing agent 220 with the IFC 224 and/or UV fusing agent 230 without the IFC 224 can be selectively applied to specific portions of the powder bed 410.

The UV fusing agent applicator 420 can be configured to print drops of the UV fusing agent 220 with the IFC 224 and the UV fusing agent 230 without the IFC 224 at a resolution ranging from about 300 dots per inch (DPI) to about 1200 DPI in some examples. Higher resolutions or lower resolutions can also be used. The volume of individual drops of UV fusing agent 220 with the IFC 224 and the UV fusing agent 230 without the IFC 224 can be from about 1 Pico liters (pL) to about 400 pL in some examples. The firing frequency of nozzles of the binding agent applicator can be from about 1 kilohertz (kHz) to about 100 kHz in certain examples.

FIG. 5 illustrates a flow diagram of an example method 500 for printing a three-dimensional object with an embedded feature of the present disclosure. In an example, the method 500 may be performed by the printing system 300 illustrated in FIG. 3 or the printing system 400 illustrated in FIG. 4 using the three-dimensional printing kit 100 illustrated in FIG. 1 or the three-dimensional printing kit 200 illustrated in FIG. 2.

At block 502, the method 500 begins. At block 504, the method 500 dispenses a layer of an optically clear build material. The optically clear build material may be a powder, a liquid, a paste, a gel, and the like. In an example, the optically clear build material may be an optically clear polymer or elastomer powder. Optically clear build materials may be transparent. In other words, optically clear build material may be defined as material that allows more than 50% of light to pass through the material.

An example of an optically clear build material may include a thermoplastic polyamide. Other example build materials include nylon, polycarbonate, polyolefins (e.g., polypropylene), polyamide copolymers, and the like.

At block 506, the method 500 dispenses a fusing agent onto a first portion of the layer of the optically clear build material. The fusing agent may be any type of fusing agent that includes a radiation absorber. In an example, the fusing agent may be a colorless UV light absorber. The colorless UV light absorber may be formulated into an aqueous solution or a solvent based solution that can be jetted or a particle dispersion in an aqueous vehicle.

For example, the colorless UV light absorber may be any type of clear or colorless radiation absorber that can absorb light having wavelengths between 320 nm to 400 nm. In an example, the colorless UV light absorber may be a substituted cresol. In an example, the colorless UV light absorber may be phenol, 2-(2H-benzotrizol-2-yl)-6-dodecyl-4-4methyl-, also known by the trade name Tinogard TL. In an example, the UV light absorber 222 may be avobenzone.

At block 508, the method 500 dispenses an invisible fluorescence compound (IFC) on a second portion of the layer of the optically clear build material, wherein the invisible fluorescence compound is to print an embedded feature in the layer that is invisible under a first light and visible under a second light. The IFC can be dispensed after melting the optically clear build material. In an example, the IFC may include any type of colorless or clear fluorescence compound. In an example, the compound may be one of TINOPAL® SFP, TINOPAL® CBS SP, TINOPAL® CBS-CL, TINOPAL® CBS-X, TINOPAL® DMA-X, TINOPAL® NFWLIQ, or combinations thereof-all available from BASF Corp (Germany).

In an example, the IFC formulated as an invisible fluorescence agent (IFA) without any UV absorber may be dispensed over portions of the optically clear build material that received the UV light absorber in the block 506. In an example, the IFC may be formulated with a UV light absorber to be dispensed on portions of the optically clear build material separately from the UV light absorber that was dispensed in the block 506.

At block 510, the method 500 applies ultraviolet (UV) light to the layer to fuse the first portion and the second portion of the optically clear build material that received the fusing agent and the invisible fluorescence agent.

The method 500 may repeat blocks 504-510 for multiple layers of the three-dimensional object that contain the embedded feature. The method 500 may repeat blocks 504, 506, and 510 for layers of the three-dimensional object that do not contain the embedded feature. Each layer may include a bound portion that forms a portion of the three-dimensional object that is to be printed. The method 500 may then melt the layers of the three-dimensional object that are bound to form a three-dimensional printed object or the final form of the three-dimensional printed object. At block 512, the method 500 ends.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method, comprising:
dispensing a layer of an optically clear build material;
dispensing a fusing agent onto a first portion of the layer of the optically clear build material;
dispensing an invisible fluorescence compound onto a second portion of the layer of the optically clear build material, wherein the invisible fluorescence compound is to print an embedded feature in the layer of the optically clear build material that is invisible under a first light and visible under a second light; and
applying ultraviolet (UV) light to the layer of the optically clear build material to fuse the first portion and the second portion of the layer of the optically clear build material that received the fusing agent and the invisible fluorescence compound.

2. The method of claim 1, wherein the fusing agent comprises a colorless ultraviolet (UV) fusing agent.

3. The method of claim 1, wherein the second portion of the layer of the optically clear build material also receives the fusing agent.

4. The method of claim 1, wherein the invisible fluorescence compound is formulated with a UV absorber to act as a second fusing agent.

5. The method of claim 1, wherein the optically clear build material comprises a thermoplastic polyamide.

6. The method of claim 1, further comprising:
repeating dispensing the layer of the optically clear build material, dispensing the fusing agent, dispensing the invisible fluorescence compound, and applying the UV light until printing of a three-dimensional part is completed.

7. A three-dimensional printed part, comprising:
layers of an optically clear build material; and
an embedded feature printed inside of the optically clear build material, wherein the embedded feature is printed with an invisible fluorescence compound such that the embedded feature is invisible under a first light and visible under a second light.

8. The three-dimensional printed part of claim 7, wherein the embedded feature comprises a security mark.

9. The three-dimensional printed part of claim 7, wherein the first light is light having a visible wavelength of light, and the second light is an ultraviolet (UV) light.

10. The three-dimensional printed part of claim 7, wherein the optically clear build material comprises an optically clear plastic.

11. The three-dimensional printed part of claim 7, wherein the invisible fluorescence compound is dispensed as an aqueous jettable formulation.

12. A three-dimensional printer, comprising:
a powder bed to receive a layer of an optically clear build material;
a first fusing agent applicator to dispense a fusing agent onto a first portion of the layer of the optically clear build material;
a second invisible fluorescence agent applicator to dispense an invisible fluorescence compound in an aqueous vehicle onto a second portion of the layer of the optically clear build material; and
an ultraviolet (UV) light source to emit UV light to fuse the first portion of the layer of the optically clear build material and the second portion of the layer of the optically clear build material.

13. The three-dimensional printer of claim 12, further comprising:
a processor to control movement of the powder bed to build each layer of a three-dimensional part that is to be printed, to control movement the first fusing agent applicator, to control movement the second invisible fluorescence agent applicator, and to control operation of the UV light source.

14. The three-dimensional printer of claim 12, wherein the invisible fluorescence compound is formulated with a UV absorber to act as a fusing agent, and the fusing agent dispensed onto the first portion of the layer of the optically clear build material is free of the invisible fluorescence compound.

15. The three-dimensional printer of claim 12, wherein the invisible fluorescence compound comprises Tinopal SFP.
